(19) United States
(12) Patent Application Publication
(10) Pub. No.: US 2025/0265853 A1
(43) Pub. Date: Aug. 21, 2025

(54) SYSTEM FOR IDENTIFYING AN ITEM IN A CAPTURED IMAGE

(71) Applicant: BEVVY LIMITED, Edinburgh (GB)

(72) Inventors: Atanas Emilov TONCHEV, Edinburgh (GB); Laurie K. BLACK, Edinburgh (GB); Luke HERON, Edinburgh (GB)

(73) Assignee: BEVVY LIMITED, Edinburgh (GB)

(21) Appl. No.: 18/857,597

(22) PCT Filed: Apr. 21, 2023
(86) PCT No.: PCT/IB2023/000387

§ 371 Date: Oct. 17, 2024

Related U.S. Application Data
(60) Provisional application No. 63/333,294, filed on Apr. 21, 2022.

(51) Int. Cl. G06V 30/19; G06V 10/25; G06V 10/74; G06V 10/94; G06V 20/62

(52) U.S. Cl. CPC G06V 30/19093; G06V 10/25; G06V 10/761; G06V 10/94; G06V 20/62

(57) ABSTRACT

A method and device for identifying an item in a captured image includes detecting a region of interest in the image. comparing the detected region of interest to a database of entries. where each database entry includes a potentially matching image region of interest and corresponding text. and returning one or more database entries that might match the item in the captured image.

### FIELD OF THE DISCLOSURE

The subject technology generally relates to capturing an image of a product and using information in the captured image to retrieve information about the product.

### BACKGROUND OF THE DISCLOSURE

“Smart” mobile devices have become ubiquitous and are our connection to information that we can access almost instantaneously. Most, if not all, smart devices include at least one camera for capturing an image. These captured images record our own activities, the actions of others and are often a record of our lives.

A captured image of an item can also be used as the basis of a query, for example, “what is this?” The item can be anything, for example, a building, a person, an animal, a plant, a product, etc. The image can be uploaded to a search engine and information about the item is returned. Of course, the returned information is only as accurate as the database that is being searched, the algorithm executing the search and the quality of the picture.

There are applications that use an image of a product to retrieve information about the product, however, the returned results can include “not found,” having too many “hits” returned, and information that is incorrect.

What is needed is a system that uses the information found in an image to quickly and accurately identify the item and provide relevant item information to the user.

### SUMMARY OF THE DISCLOSURE

In one aspect of the present disclosure a method for identifying an item in a captured image includes detecting text in the image, comparing the detected text to a database of entries, where each database entry includes a potentially matching item and corresponding text, and returning one or more database entries that might match the item in the captured image.

In another aspect of the present disclosure a method for identifying an item in a captured image includes detecting a region of interest in the image, comparing the detected region of interest to a database of entries, where each database entry includes a potentially matching image region of interest and corresponding text, and returning one or more database entries that might match the item in the captured image.

### BRIEF DESCRIPTION OF THE DRAWINGS

Various aspects of the present disclosure are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity; and/or several physical components may be included in one functional block or element. Further, where considered appropriate, reference numerals may be repeated among the drawings to indicate corresponding or analogous elements. For purposes of clarity, however, not every component may be labeled in every drawing. The figures are provided for the purposes of illustration and explanation and are not intended as a definition of the limits of the disclosure. In the figures:

FIG. 1 is a conceptual representation of an aspect of the present disclosure;

FIG. 2, consisting of FIGS. 2A and 2B, is a flowchart of a method in accordance with an aspect of the present disclosure;

FIG. 3 is a flowchart of a product identification function in accordance with an aspect of the present disclosure;

FIG. 4 is a flowchart of an autocorrect function in accordance with an aspect of the present disclosure;

FIG. 5 is a flowchart of a product identification function in accordance with an aspect of the present disclosure;

FIG. 6 is an example of a “Scan” screen in accordance with an aspect of the present disclosure;

FIG. 7 is an example of a “Whisky Profile” screen in accordance with an aspect of the present disclosure;

FIG. 8 is an example of a “User Profile” screen in accordance with an aspect of the present disclosure;

FIG. 9 is an example of a “Distillery Profile” screen in accordance with an aspect of the present disclosure;

FIG. 10 is an example of a “Whisky Not Found” screen in accordance with an aspect of the present disclosure;

FIG. 11 is an example of a “Multiple Potential Matches Found” screen in accordance with an aspect of the present disclosure; and

FIG. 12 is a flowchart of a product identification function in accordance with an aspect of the present disclosure.

### DETAILED DESCRIPTION

In the following detailed description, numerous specific details are set forth in order to provide a thorough understanding of the aspects and implementations of the present disclosure. It will be understood by those of ordinary skill in the art that these may be practiced without some of the specific details that are set forth. In some instances, well known methods, procedures, components and structures may not have been described in detail so as not to obscure the details of the implementations of the present disclosure.

It is to be understood that the details of construction in the arrangement of the components set forth in the following description or illustrated in the drawings are not limiting. There are other ways of being practiced or carried out. Also, it is to be understood that the phraseology and terminology employed herein are for the purposes of description only and also should not be regarded as limiting.

Further, certain features, which are described in the context of separate implementations, may also be provided in combination in a single implementation. Conversely, various features, which are, for brevity, described in the context of a single implementation may also be provided separately or in any suitable sub-combination.

In one aspect of the present disclosure, the subject technology provides improvements over the prior art, including a new and unique system, method and apparatus for identifying an item in an image.

As a non-limiting example, aspects of the present disclosure are explained with respect to a specific item, i.e., a bottle of whisky. It should be understood, however, that the concepts and teachings presented herein are applicable to many other types of items that a user may want to identify.

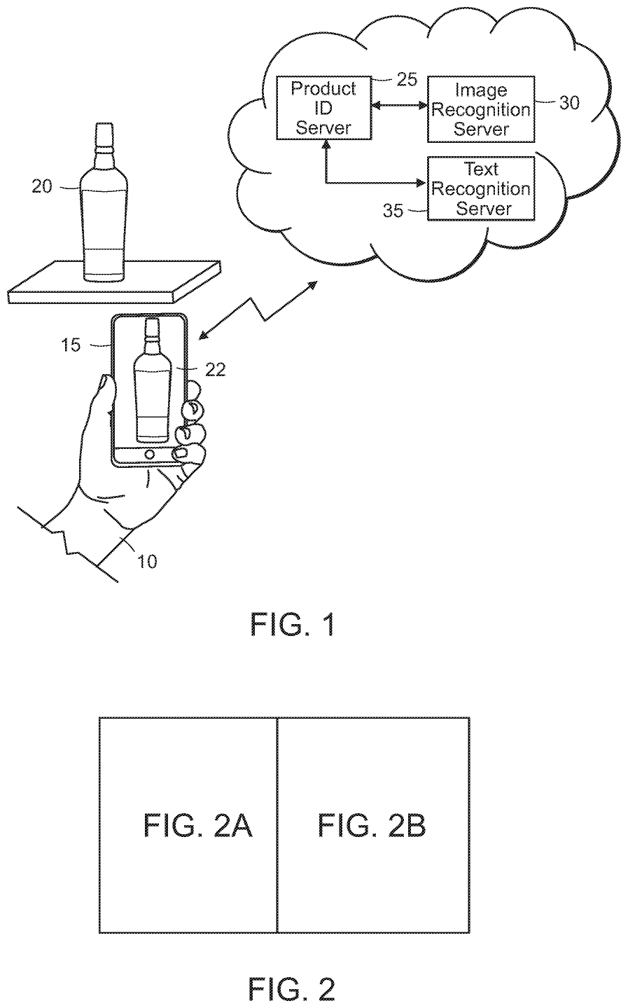

Referring now to FIG. 1, in an example that is only for explanatory purposes, a user 10 operates their smart device 15 to obtain more information about an item 20, for example, a bottle of whisky. The user obtains an image 22, i.e., a digital image, and wirelessly transmits it, via an application running on the device 15, to the cloud. The received image 22 is processed by a product ID server 25 in communication with an image recognition server 30 and a text recognition server 35. Information about the item 20 identified from the image 20 is then presented to the user on a display of the device 15.

It should be noted that, while one aspect of the present disclosure shows some operations as being performed in the cloud, one of ordinary skill in the art will understand that all operations described herein may be performed on the device 15. Further, the device 15 is not limited to a smartphone, i.e., a device that also functions as a mobile phone, but could be on any device, portable or not. that can capture a digital image, for example, a tablet or a laptop computer.

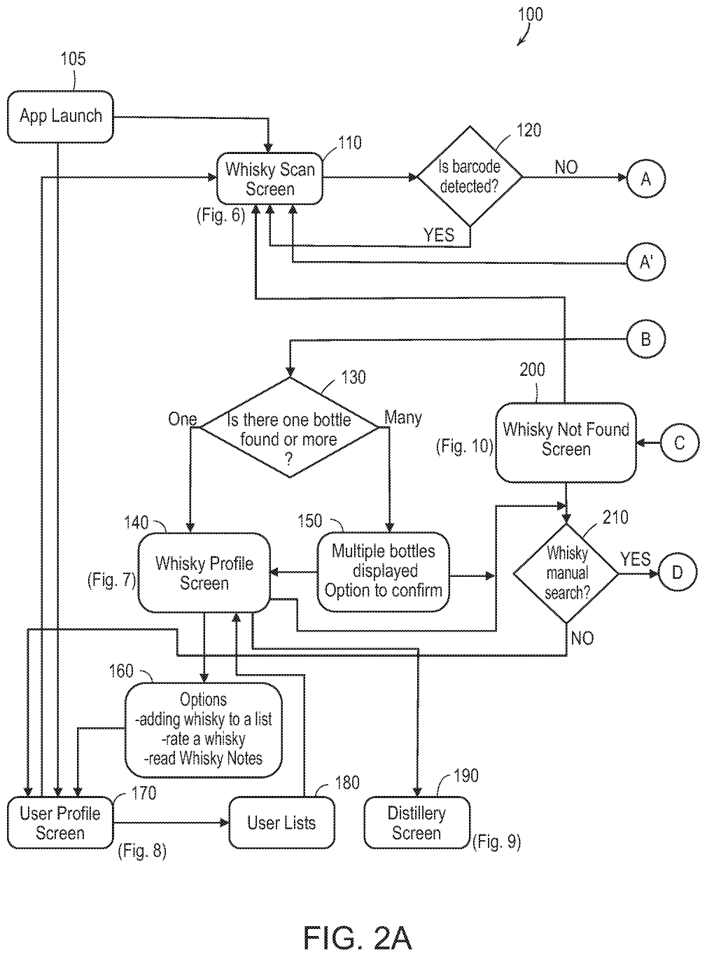

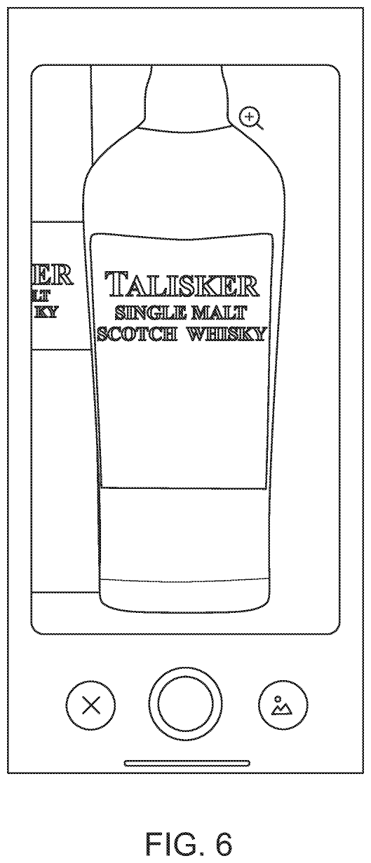

In accordance with an aspect of the present disclosure, a method 100 starts at Step 105 where an application is launched on the device 15. Control passes to Step 110 where a “Scan Screen” is presented to the user, an example of which is shown in FIG. 6. Here, the user captures an image of a whisky, usually a single bottle of whisky, about which more information is desired. This could be in a liquor store where the user is trying to make a selection for purchase. At Step 120, the image is analyzed to determine if a barcode has been captured in the image. If so, control passes back to Step 110 where the user is prompted to take another picture without the barcode being shown. Once an image is captured without a barcode, control passes to Step 1000, shown in FIG. 2B.

As has already been noted, the operations shown in FIG. 2A and FIG. 2B may be distributed between the device 15 and the cloud. In one aspect of the present disclosure, the functions shown in FIG. 2A may be implemented on the device 15 and the functions shown in FIG. 2B implemented in the cloud. Alternatively, all of the functions shown in FIGS. 2A and 2B may be implemented on the device 15. Of course, one of ordinary skill in the art will understand that some subset of the functions shown in FIG. 2B may be implemented on the device 15. Generally, aspects of the present disclosure are not to be limited by the arrangement of the functions shown in FIGS. 2A and 2B.

The image is received at Step 1000 and a determination as to the focus of the image is made at Step 1010. A blurry image is not amenable to an accurate determination of the item. If the focus is good, control passes to Step 1020, where Optical Character Recognition (OCR) is applied to the image and any text in the image is identified and the identified words are returned to Step 1030. If, however, the focus is not acceptable, control returns to Step 110 and the user is prompted to capture another image. The OCR function may be implemented within the device 15 or a web service such as Google OCR or Amazon Rekognition may be used.

At Step 1030, specific words that fall into a category relevant to identifying the whisky in the captured image are extracted, i.e., identified, from the words or phrases received from the OCR operation 1020. Once these words are identified in the image and their respective category identified, a multi-level search based on those identified words and corresponding category is performed on a database storing an extensive collection of whisky information in order to identify at least one whisky as matching the image captured by the user. The categories are: Distillery (D), Bottler (B), Distillery Keywords (DK), Year (Y). Age (A), and Strength (S).

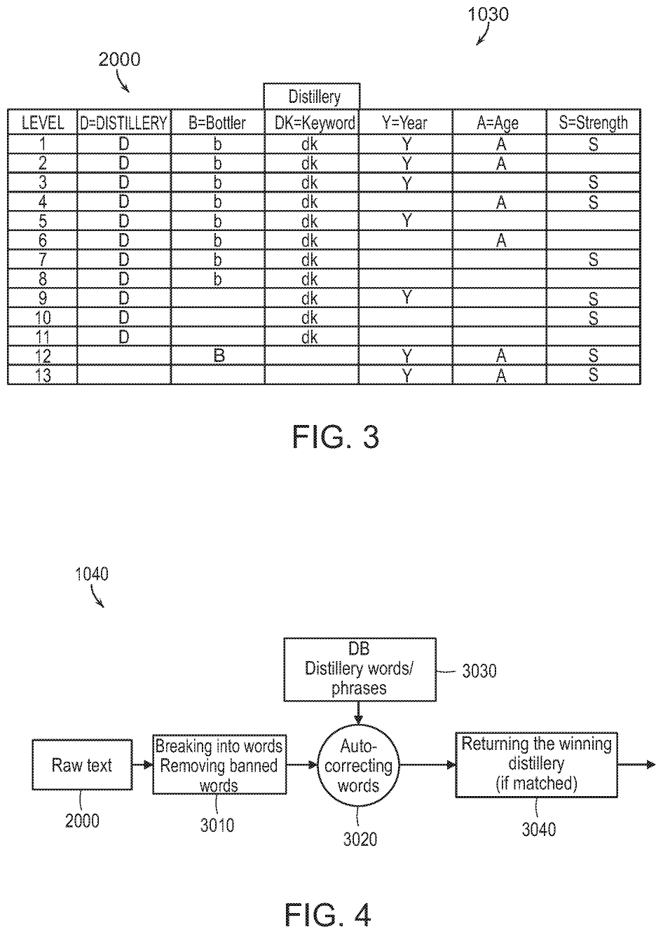

If a Distillery has not been identified in the words returned from the OCR operation 1020, then the text is put through an “autocorrect” function at Step 1040. As shown in FIG. 4, the “raw” text 2000, for example, the text identified in Step 1020, is received and broken into words with banned or irrelevant words being removed at Step 3010. At Step 3020, the words from Step 3010 are compared to a database 3030 of distillery words and phrases and an identified distillery, if one is found in the database, is returned at Step 3040.

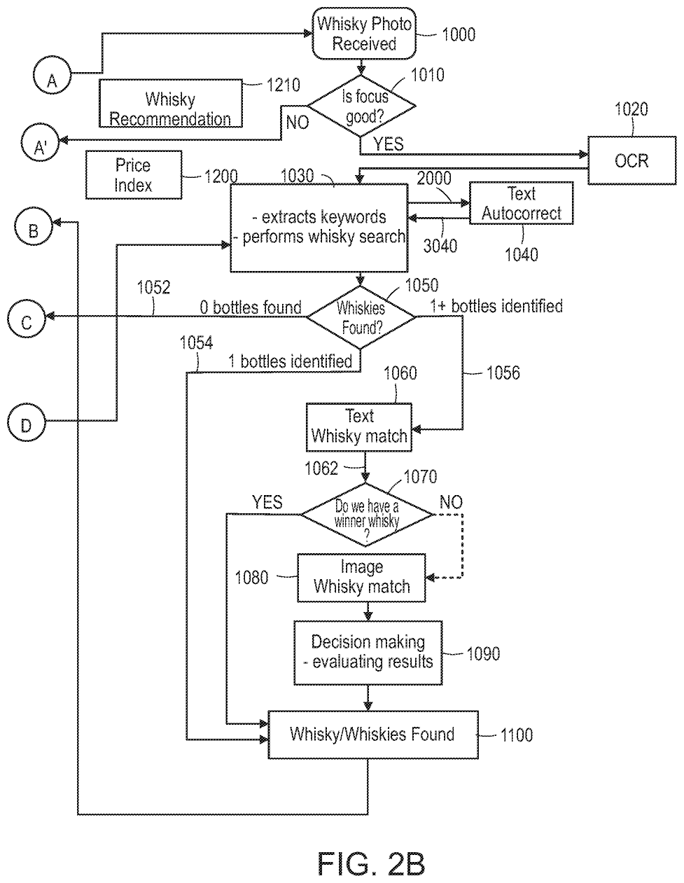

As will be described with reference to FIG. 3, each level of the multi-level search 1030, as represented in a Table 2000, uses a respective value in each category of words: Distillery (D), Bottler (B), Distillery Keywords (DK), Year (Y), Age (A), and Strength (S) to try to identify the whisky in the captured image. With reference to each level, a search tuple ST(x), where x is the level, will consist of those categories with identified words shown in uppercase letters, meaning that a value has to have been found, i.e., is necessary, for that category in order to search at that level but where a value in lowercase is optional, i.e., “don't care” or “d/c,” for that level. A search to identify the whisky in the captured image, therefore, starts at Level 1 and if at least one whisky is not identified as matching the image from ST(1), then a search at Level 2, ST(2), is performed, and so on, until at least one whisky is identified as possibly matching the image or there are no matches to the database. As the levels progress, one can see that the tuples change.

As an example, assume that values D, B, Y, A, S are identified from the captured image, then ST(1)=(D, B, d/c, Y, A, S) and any whiskies matching ST(1). i.e., having the values D, B, Y, A. S, are identified in the database. Here “d/c” means “don't care” because the distillery keyword (DK) value is not known and is not needed at this level. If no match is found at Level 1, then the process moves to Level 2, where ST(2)=(D, B, d/c, Y, A, d/c) and any whiskies matching ST(2), i.e., having the values D, B, Y, A are identified in the database. Moving from one level to the next changes the search parameters and it should be noted that the differences from one level to the next are chosen to most efficiently identify a whisky without an undue number of false positive hits. The number of levels, their order, and the parameters in each level, are presented here to explain aspects of the present disclosure and may change over time as a function of, for example, the information in the database and optimization analyses. Accordingly. the levels described in the present disclosure are for explanatory purposes only and are not intended to be limiting.

When the multilevel search 1030 has completed, the output is provided to Step 1050 where it is determined if any whiskies have been identified, i.e., whether zero, one, or more than one, whiskies have been returned from the search 1030. If one bottle of whisky has been identified, then control passes along a path 1054 to Step 1100 indicating that one whisky has been identified and control then passes to Step 130.

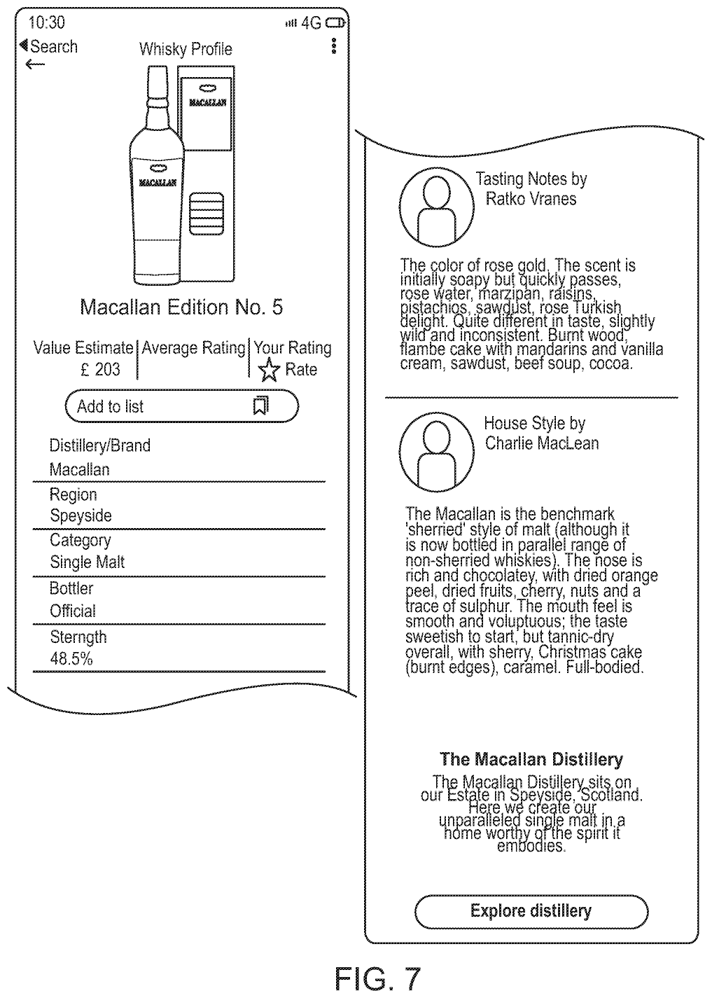

At Step 130, it is determined if one or many whiskies have been found, and when just one has been found, control passes to Step 140 where a “Whisky Profile” screen, an example of which is shown in FIG. 7, is presented to the user on their device. It should be noted that, in one aspect of the present disclosure, the data from any of Step 1030 or Step 1100 received at Step 120 includes information for one or more bottles. That received data includes a variable that determines the screen and data to display and Step 130 operates on the data sent to determine the next screen.

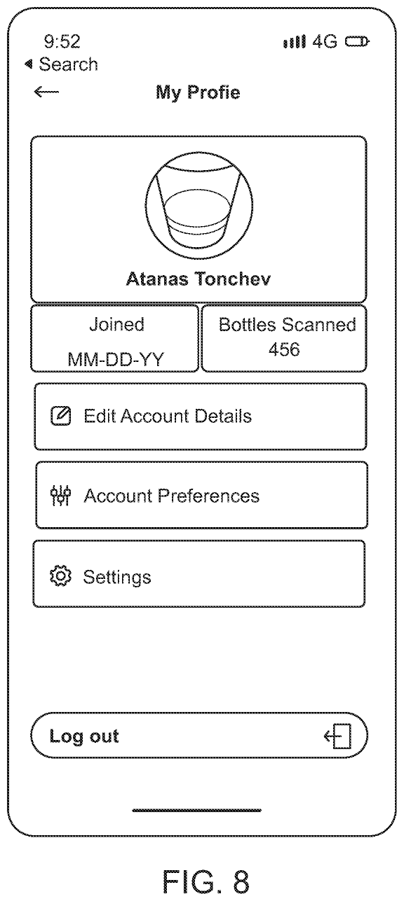

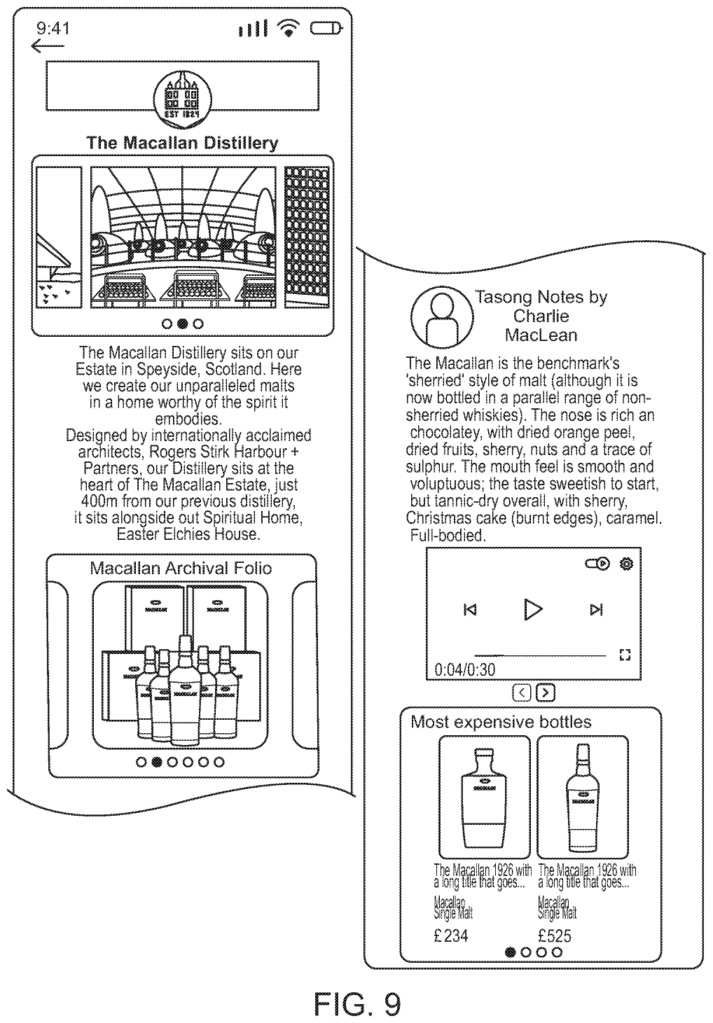

Subsequently, Step 160, the user has the option of adding the found whisky to a list associated with their profile, rating the whisky, and/or reading notes from others regarding that whisky. The user then can return, Step 170, to their profile screen as shown in FIG. 8. The user can then proceed to Step 180 and review their list of whiskies and return to Step 140 and proceed to Step 190 where they can view a Distillery screen, as shown in FIG. 9, having information about a distillery in their list.

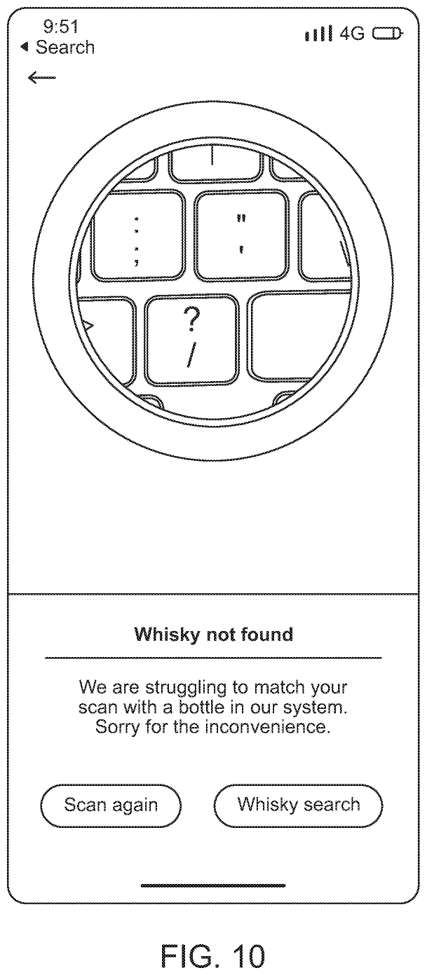

Returning to Step 1050, if zero matching bottles were found, control passes along a path 1052 to Step 200 and a “Whisky Not Found” screen, as shown in FIG. 10, is presented to the user on their device. At Step 210, the user may choose to perform a manual search for the whisky in the image and control passes to Step 1030 and a new search is initiated, otherwise, the user may be directed to Step 170. Step 1030 performs a multi-level search based on the text entered by the user as has been described herein.

Returning now to Step 1050, if more than one whisky has been identified as a potential match, then control passes along a path 1056 to Step 1060 where a process is implemented to identify a least number of potential matches for the whisky in the image.

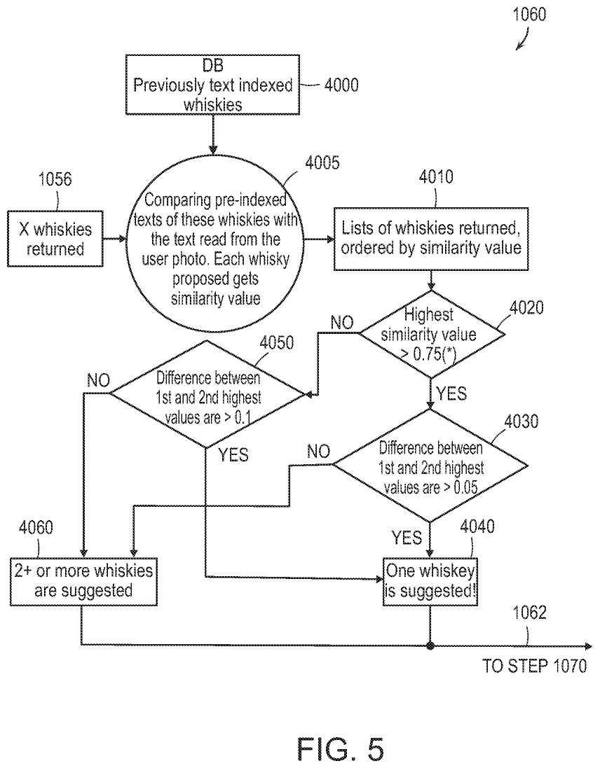

At Step 1060, referring to FIG. 5, each of the plurality of potentially matching whiskies from Step 1030 is received along the path 1056 at Step 4005. Each entry in a database 4000 includes a whisky and associated, or corresponding, text, i.e., it is a text-indexed database of whiskies. At Step 4005, the entry in the database 4000 for each potentially matching whisky from Step 1030 is retrieved and the corresponding text for that entry is compared with the text that was identified in the captured image. Each potentially matching whisky is assigned a similarity value (SV), where 0≤SV≤1, based on that comparison. It is well understood by those of ordinary skill in the art that there are many approaches to measuring similarity including, but not limited to, the similarity functions in the Python programming language.

Once each potentially matching whisky has an associated SV, control passes to Step 4010 where the list is ordered according to SV. At Step 4020, it is determined if a highest SV of any potentially matching whisky is an SV>0.75 and, if so, control passes to Step 4030. At Step 4030, if a difference in respective SVs for the potentially matching whiskies with the highest SV and next-highest SV is greater than 0.05, then control passes to Step 4040 where the one whiskey with the highest SV is sent along a path 1062 to Step 1070.

At Step 4030, if a difference in respective SVs for the potentially matching whiskies with the highest SV and next-highest SV is not greater than 0.05, then control passes to Step 4060 which is discussed below.

Returning to Step 4020, if the highest SV≤0.75, then control passes to Step 4050 and if a difference in respective SVs for the potentially matching whiskies with the highest SV and next-highest SV is greater than 0.1, then control passes to Step 4040 where the one whiskey with the highest SV is sent along the path 1062 to Step 1070.

Returning to Step 4050, if the difference in respective SVs for the potentially matching whiskies with the highest SV and next-highest SV is not greater than 0.1, then control passes to Step 4060 where information relating to the at least the top two or more potentially matching whiskies are sent along the path 1062 to Step 1070.

One of ordinary skill in the art will understand that the values set forth in Steps 4020, 4030, and 4050, are for example only and not to be considered as limiting.

At Step 1070, it is determined if at least one potentially matching whisky has been received and, if so, control passes to Step 1100 where, if only one whisky has been identified, then information about the one whisky is passed to Step 130 as discussed herein. If more than one potentially matching whisky has been identified, control passes to Step 1100 and then to Step 130, where information about the top two or more potentially matching whiskies is passed along.

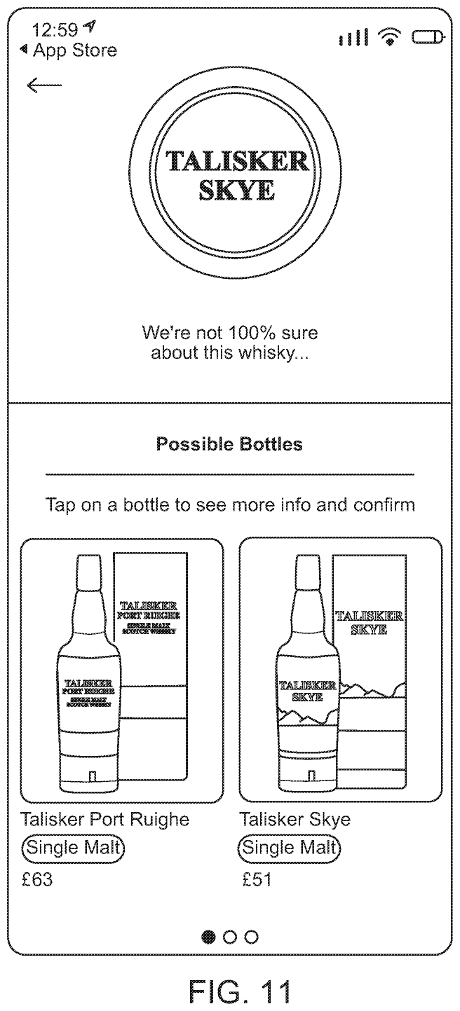

If many, i.e., two or more, potentially matching whiskies are received at Step 130, control passes to Step 150 where the user is presented with a screen. as shown in FIG. 11, displaying the two or more potentially matching whiskies. The user is then instructed to review the presented whiskies and determine which best matches the actual bottle of whisky, which is presumed to be in front of, or at least near, the user. If one whisky is identified as matching, control passes to Step 140, otherwise control passes to Step 210 where the user is given the option to return to Step 170 or conduct a manual search and then operation continues as discussed herein.

Returning now to Step 1070, if no potentially matching whisky is identified, control passes to Step 1080 where image comparison and matching is performed. The image comparison at Step 1080 is analogous to the text matching performed at Step 1060.

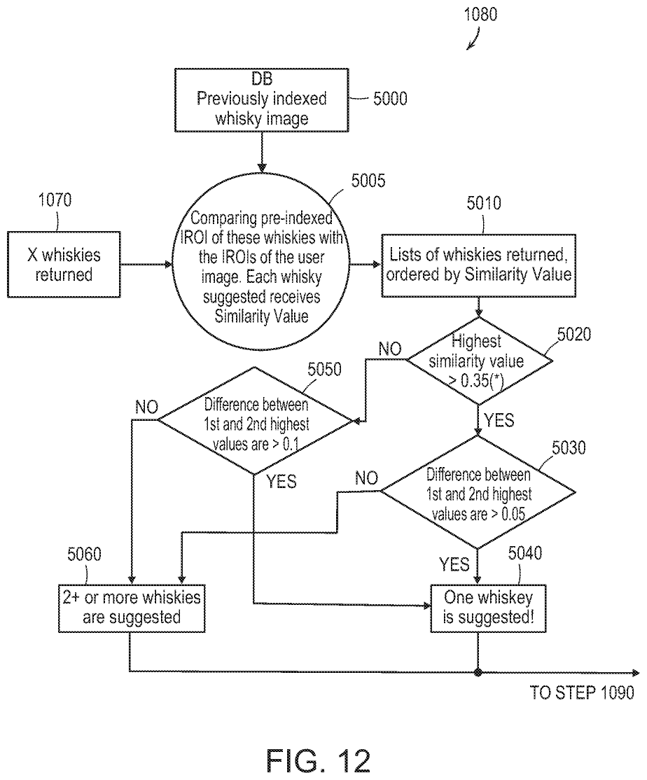

In Step 1080, as shown in FIG. 12, a database 5000 is maintained where each whisky has a corresponding Image Region of Interest (IROI) associated with it. An IROI is an element or a region in an image that is extracted and stored in, for example. binary format. Multiple IROIs may be extracted from a single whisky image and then stored as elements of that whisky in the database 5000. Each entry in the database 5000, therefore, includes a whisky and one or more associated, or corresponding, image, i.e., it is an image-indexed database of whiskies.

The image captured by the user may be processed, for example, cropped down to that portion of the image that is located in the visible area on the screen. In this case, cropping is applied because most phone cameras save a full-size image, and, advantageously, cropping reduces the image to fewer bytes resulting in the image being transmitted more quickly.

Once received, the image may be processed to include just the bottle in order to remove any additional objects in the image that might be behind or next to the bottle. IROIs from the user image are captured in a same manner as the image-indexing for existing whisky images in the database 5000 were processed.

Each of the plurality of potentially matching whiskies from Step 1070 is received at Step 5005. At Step 5005, the entry in the database 5000 for each potentially matching whisky from Step 1070 is retrieved and the corresponding image for that entry is compared with one or more IROIs identified in the captured image. Each potentially matching whisky is assigned an Image Similarity Value (ISV), where 0≤ISV≤1, based on that comparison. It is well understood by those of ordinary skill in the art that there are many approaches to measuring similarity including. but not limited to, the similarity functions in the Python programming language.

Once each potentially matching whisky has an associated ISV, control passes to Step 5010 where the list is ordered according to ISV. At Step 5020, it is determined if a highest ISV of any potentially matching whisky is an ISV>0.35 and, if so, control passes to Step 5030. At Step 5030, if a difference in respective ISVs for the potentially matching whiskies with the highest ISV and the next-highest ISV is greater than 0.05, then control passes to Step 5040 where the one whiskey with the highest ISV is sent to Step 1070.

At Step 5030, however, if a difference in respective ISVs for the potentially matching whiskies with the highest ISV and next-highest ISV is not greater than 0.05, then control passes to Step 5060 which is discussed below.

Returning to Step 5020, if the highest ISV≤0.35, then control passes to Step 5050 and if a difference in respective ISVs for the potentially matching whiskies with the highest ISV and the next-highest ISV is greater than 0.1, then control passes to Step 5040 where the one whiskey with the highest ISV is sent to Step 1090.

Returning to Step 5050, if the difference in respective ISVs for the potentially matching whiskies with the highest ISV and next-highest ISV is not greater than 0.1, then control passes to Step 5060 where information relating to the at least the top two or more potentially matching whiskies are sent to Step 1090.

One of ordinary skill in the art will understand that the values set forth in Steps 5020, 5030, and 5050, are for example only and not to be considered as limiting.

In one embodiment of the present disclosure, a Step 1090 takes the results from Step 1060 and Step 1070 when more than one potentially matching whisky has been found in order to determine which is the most likely to match. The analysis may be a comparison of the results or application of an algorithm based on historical trends. One or more potentially matching whiskies may then be identified from the combination of Steps 1060 and 1070.

From Step 1090, control passes to Step 1100. The method then proceeds from there as described herein.

A Price Index database 1200 may be provided having information relative to prices for bottles of whiskies as either identified in a search or retrieved by a user. The information may be retrieved and presented to the user in association with the identified whisky. In addition, a Whisky Recommendation database 1210 may be provided having information relative to recommendations for whiskies that might be similar to a whisky as either identified in a search or retrieved by a user. The information may be retrieved and presented to the user in association with the identified whisky.

The foregoing examples of aspects of the present disclosure include a user capturing an image of a bottle of whisky and the system then identifying text and/or image regions of interest in the captured image in order to identify the whisky. In addition, a user may manually input search terms for the system to search. In another aspect of the present disclosure, a user my capture an image of text, e.g., “NIKKA COFFEY GRAIN WHISKY.” This image would then be analyzed as described herein and the text identified and then used to identify potentially matching whiskies. Further, the captured image of a bottle of whisky need not be of a real three-dimensional bottle but could be an image captured from a two-dimensional representation, for example, a monitor screen or a poster. While the examples set forth above are directed to whisky, it will be appreciated by those skilled in the art that other spirits may be identified. Likewise, the invention according to this disclosure contemplates that databases may be established for other beverages or consumer products.

As used throughout this application, the word “may” is used in a permissive sense (i.e., meaning having the potential to) rather than the mandatory sense (i.e., meaning must). Similarly, the words “include,” “including,” and “includes” mean including, but not limited to.

From the foregoing disclosure, it will be appreciated that, although specific implementations have been described herein for purposes of illustration, the implementations are not limited to the examples or drawings described. Various modifications may be made without deviating from the spirit and scope of the disclosure. In addition, while certain aspects have been presented as optional or alternate embodiments, all such embodiments are not required and thus may be incorporated as dictated by the circumstances to achieve the desired result. Various modifications and changes may be made as would be obvious to a person skilled in the art having the benefit of this disclosure. It is intended to embrace all such modifications and changes, and accordingly, the above description should be regarded in an illustrative rather than restrictive sense.

We claim:

1. A system for identifying an item in an image comprising:
an application running on a device capable of receiving an image from the device; and
a product ID server in communication with an Optical Character Recognition (OCR) server and a text recognition server capable of receiving the image from the device.

2. The system of claim 1 wherein the device is a mobile phone, a laptop computer, or any other device capable of capturing an image.

3. The system of claim 1 wherein the product ID server identifies an object in the image from the device and relays information about an identified object back to a user.

4. The system of claim 1 wherein the application and the product ID server function remotely in a cloud server or locally on the smart device.

5. The system of claim 1 wherein the product identification server may identify at least one image region of interest (IROI) from the image and the IROI may be stored in binary form.

6. A method of identifying an item in a captured image, the method comprising:
capturing an image containing one or more objects with a device;
transmitting a captured image to a product ID server, the product ID server in communication with an Optical Character Resolution (OCR) server and a text recognition server;
identifying and processing text and/or regions of interest contained on the one or more objects in the captured image; and
providing information to a user about the one or more objects seen in the captured image.

7. The method of claim 6 wherein a barcode is recognized in the captured image and the user is prompted to further photograph the barcode.

8. The method of claim 6 wherein the captured image is deemed unacceptable and the user is prompted to photograph a clearer image.

9. The method of claim 6 wherein no barcode is found in the captured image and the image is subject to OCR.

10. The method of claim 9 wherein characters from the captured image were not recognized by the OCR and are then subject to an autocorrect function to cure potential deficiencies.

11. The method of claim 9 wherein the OCR identifies zero objects in the captured image and the user is prompted to manually enter the object's identifying information.

12. The method of claim 9 wherein one object is identified in the captured image and the user is presented with an object profile for the identified object.

13. The method of claim 9 wherein more than one object is identified in the captured image and the more than one identified objects from the captured image are subject to text recognition.

14. The method of claim 13 wherein an image similarity value (ISV) is assigned to each of the more than one identified objects of the captured image based on the more than one identified object's similarity to the object in the captured image.

15. The method of claim 13 wherein the user is presented with a list of potentially matching objects and is prompted to choose the object that most closely resembles the object in the captured image.

16. The method of claim 14 wherein a list of more than one identified objects is returned to the user and ranked based on ISV.

17. The method of claim 13 wherein the text recognition does not recognize the object in the captured image and the object in the captured image is further subjected to image matching.

18. The method of claim 13 wherein the text recognition comprises a multi-level search.

19. The method of claim 9 wherein a user may rate, take notes on, or add objects of the captured image to a list.
